(19) United States
(12) Patent Application Publication
(10) Pub. No.: US 2012/0145697 A1
(43) Pub. Date: Jun. 14, 2012

(54) HEAT TREATMENT APPARATUS

(75) Inventors: Tomohito Komatsu, Nirasaki-shi (JP); Takayuki Kamaishi, Nirasaki-shi (JP); Ryoji Yamazaki, Nirasaki-shi (JP)

(73) Assignee: TOKYO ELECTRON LIMMITED, Tokyo (JP)

(21) Appl. No.: 13/390,825

(22) PCT Filed: Aug. 11, 2010
(86) PCT No.: PCT/JP2010/063617

§ 371 Date: Feb. 16, 2012

(30) Foreign Application Priority Data
Aug. 18, 2009 (JP) 2009-188930

(51) Int. Cl. F27D 11/00

(52) U.S. Cl. 219/438

(57) ABSTRACT

A heat treatment apparatus is configured to include: a treatment chamber for accommodating therein a wafer; a substrate supporting unit for horizontally supporting the wafer in the treatment chamber; and a lamp unit provided above the treatment chamber. The lamp unit includes: a base member; a plurality of lamps provided on the lower surface of the base member whose front ends face downwardly; a plurality of ring-shaped reflectors concentrically provided on the lower surface of the base member to protrude downward; and a cooling head for supplying a cooling medium into the reflectors. At least some of the lamps are arranged along the reflectors, and cooling medium channels, each inner space of which is formed as a ring-shaped space, are respectively provided within the reflectors in the extending directions of the reflectors.

### FIELD OF THE INVENTION

The present invention relates to a heat treatment apparatus capable of rapidly increasing and decreasing a temperature of a substrate.

### BACKGROUND OF THE INVENTION

When a semiconductor device is manufactured, various heat treatments such as a film forming process, an oxidation/diffusion process, a modification process, an annealing process and the like are performed on a semiconductor wafer (hereinafter, simply referred to as a wafer) as a target substrate to be processed. Among the heat treatments, especially an annealing process for removing distortion after film formation or an annealing process after ion implantation requires a high-speed temperature control for raising or lowering the process temperature in order to improve a throughput and minimize diffusion. As for a heat treatment apparatus capable of performing a high-speed temperature control, an apparatus using a halogen lamp as a heating source is widely used.

As for a heat treatment apparatus using such lamp, there is known an apparatus having a heating unit in which a plurality of double ended lamps is entirely arranged in a planar array (e.g., Japanese Patent Application Publication No. 2002-064069 (JP2002-064069A)). Further, there is known an apparatus having a heating unit in which a plurality of single ended lamps is arranged vertically and each of the lamps is covered by a light pipe serving as a reflector (e.g., U.S. Pat. No. 5,840,125 (U.S. Pat. No. 5,840,125A1).

In the technique described in JP2002-064069A, the arrangement density of the lamps and the luminous density per lamp are limited and, thus, the heating efficiency is not sufficient.

In the technique described in U.S. Pat. No. 5,840,125A1, the arrangement density of the lamps can be increased because the lamps are vertically arranged. Since, however, a light from a lamp reaches a wafer as a target substrate to be processed after being repetitively reflected in small spaces between the lamps and light pipes, the light is absorbed as heat by the light pipes at a high rate and the energy efficiency becomes low.

The temperatures of the light pipes serving as reflectors are considerably increased by the light from the lamps, so that the light pipes need to be cooled by circulating a cooling medium such as a cooling water or the like between the light pipes. Since, however, a light pipe is provided for each of the lamps, the flow of the cooling medium is disturbed by the light pipes and, thus, a conductance of a cooling water channel is decreased. Accordingly, cooling efficiency is decreased, and a supply pressure of the cooling water needs to be increased to ensure sufficient cooling.

### SUMMARY OF THE INVENTION

In view of the above, the present invention provides a heat treatment apparatus capable of effectively cooling reflectors and heating a target substrate to be processed with high energy efficiency by using lamps.

In accordance with an aspect of the present invention, there is provided a heat treatment apparatus including: a processing chamber for accommodating therein a target substrate to be processed; a substrate supporting unit for horizontally supporting the target substrate in the processing chamber; a lamp unit for emitting lights to the target substrate supported by the substrate supporting unit through an opening formed at the processing chamber; and a lamp unit supporting unit for supporting the lamp unit. The lamp unit includes: a plurality of lamps whose leading ends face the target substrate supported by the substrate supporting unit; a base member holding the lamps; a plurality of ring-shaped reflectors provided on the base member concentrically about a portion corresponding to the center of the target substrate and protruded toward the target substrate, to the reflectors serving to reflect the lights emitted from the lamps toward the target substrate; and a cooling medium supply unit for supplying a cooling medium into the reflectors. At least some of the lamps are arranged along the reflectors, and cooling medium channels, each inner space of which is formed as a ring-shaped space, are respectively provided within the reflectors in extending directions of the reflectors.

In accordance with the present invention, the lamps are arranged in such a way that front ends thereof face the target substrate, so that the arrangement density of the halogen lamps and the luminous efficiency of the lamps can be increased compared to the case where the halogen lamps are arranged in a planar manner on a surface.

Besides, the reflectors are provided on the surface of the base member which faces the target substrate so as to form a concentric shape about a portion corresponding to the center of the target substrate and protrude toward the target substrate, and the lamps are arranged along the reflectors. Therefore, lights from the lamps can reach the target substrate without repetitive reflection occurring when the light pipes are provided as reflectors. Accordingly, the amount of energy absorbed as heat can be reduced, and the energy efficiency can be increased.

In addition, the cooling medium channel made of a ring-shaped space is formed within the concentrically arranged reflectors, so that the conductance of the cooling medium is decreased and the reflectors can be effectively cooled.

### BRIEF DESCRIPTION OF THE DRAWINGS

FIG. 1 is a cross sectional view showing an annealing apparatus as a heat treatment apparatus in accordance with a first embodiment of the present invention.

FIG. 2 is a bottom view showing a lamp unit of the annealing apparatus shown in FIG. 1.

FIG. 3 is a perspective view showing an exterior appearance of the lamp unit of the annealing apparatus shown in FIG. 1.

FIG. 4 is a perspective view showing a state in which lamp modules are removed from the lamp unit.

FIG. 5A schematically shows a configuration of a first lamp module.

FIG. 5B schematically shows a configuration of a second lamp module.

FIG. 5C schematically shows a configuration of a third lamp module.

FIG. 5D schematically shows a configuration of a fourth lamp module.

FIG. 6 is a side view for explaining a structure of a halogen lamp.

FIG. 7 explains a distance between halogen lamps adjacent to each other.

FIG. 8 is a cross sectional view showing a structure of a reflector.

FIG. 9 is a perspective view showing a frame of a reflector before attachment of a metal plate serving as a reflection unit having a reflective surface.

FIG. 10 shows a simulation of lights emitted from a halogen lamp and lights reflected from a reflector when the halogen lamp in a fourth zone is inclined by about 45°.

FIG. 11 is a cross sectional view for explaining a cooling head and a structure for supplying a cooling medium from the cooling head into reflectors.

FIG. 12 is a cross sectional view showing a part of a lamp unit of an annealing apparatus in accordance with a second embodiment of the present invention.

FIG. 13 is a cross sectional view showing principal parts of the lamp unit shown in FIG. 11.

FIG. 14 is a perspective view showing how halogen lamps are attached in the second embodiment.

FIG. 15 is a cross sectional view showing principal parts of an annealing apparatus in accordance with a third embodiment of the present invention.

FIG. 16 is a cross sectional view showing a light transmitting plate supporting portion of the annealing apparatus in accordance with the third embodiment.

FIG. 17 is a perspective view showing how a cover provided on a top surface of a light transmitting plate of the annealing apparatus in accordance with the third embodiment is attached.

FIG. 18 is a bottom view showing a lamp unit of an annealing apparatus in accordance with a fourth embodiment of the present invention.

FIG. 19 is a bottom view showing a lamp unit of an annealing apparatus in accordance with a fifth embodiment of the present invention.

### DETAILED DESCRIPTION OF THE EMBODIMENTS

Hereinafter, embodiments of the present invention will be described with reference to the accompanying drawings which form a part hereof.

### First Embodiment

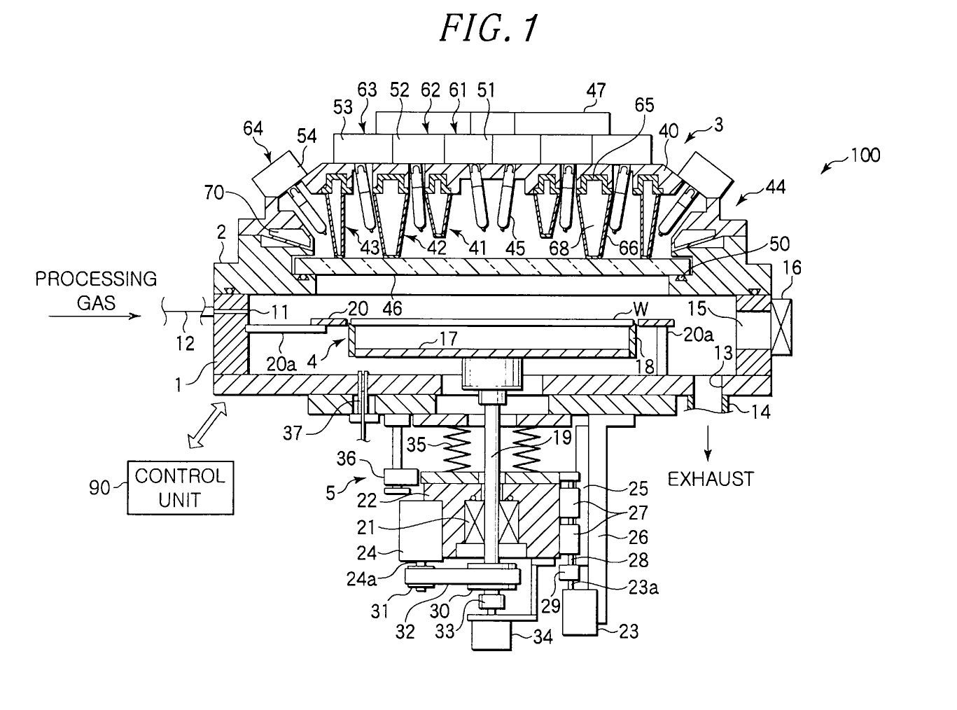

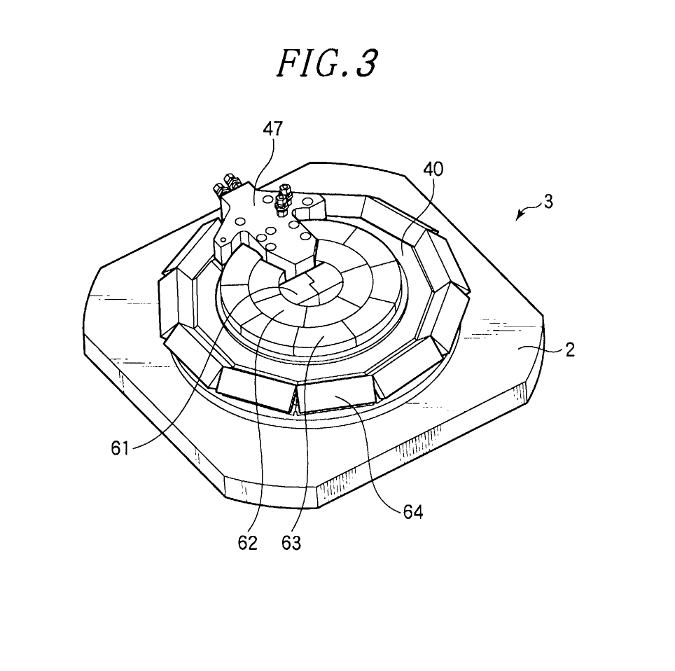

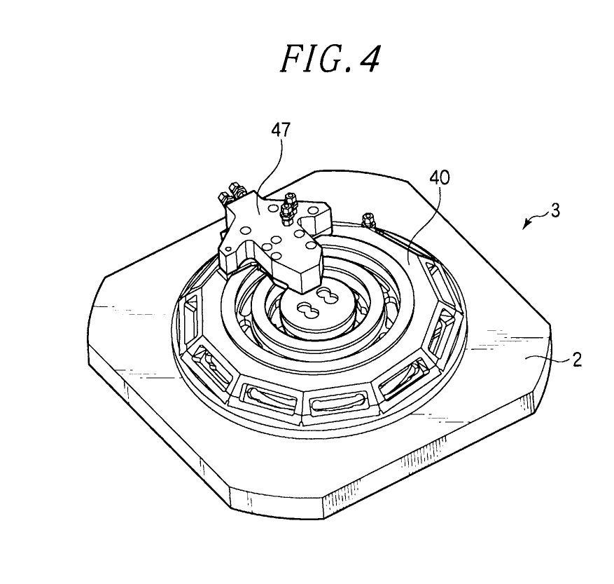

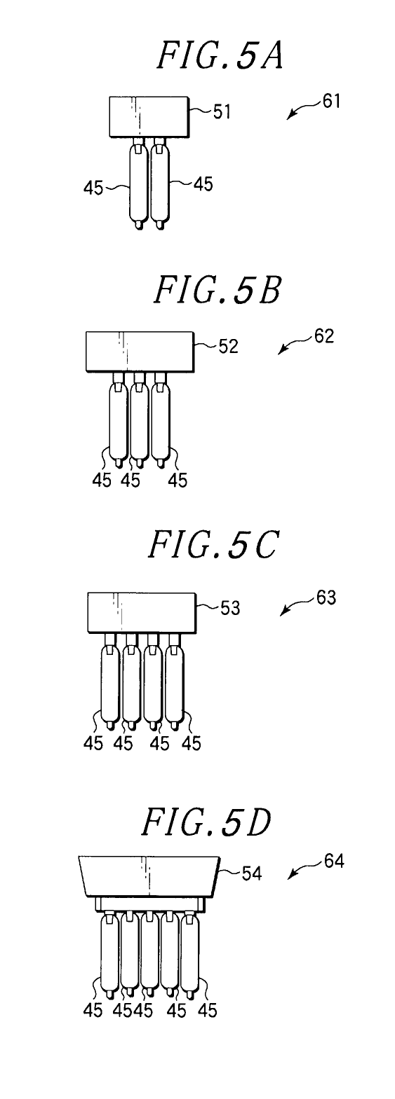

FIG. 1 is a cross sectional view showing an annealing apparatus as a heat treatment apparatus in accordance with a first embodiment of the present invention. F g. 2 is a bottom view showing a lamp unit thereof. FIG. 3 is a perspective view showing an exterior appearance of the lamp unit. FIG. 4 is a perspective view showing a state in which lamp modules are removed from the lamp unit. FIGS. 5A to 5D schematically show configurations of the lamp modules.

An annealing apparatus 100 mainly includes: a processing chamber 1 defining a processing space in which a wafer W as a target substrate is processed; a ring-shaped lid 2 fixed to an upper end of the processing chamber 1; a lamp unit 3, supported by the lid 2, having a plurality of halogen lamps; a wafer support 4 for supporting the wafer W in the processing chamber 1; and a driving unit 5 for raising, lowering and rotating the wafer W supported by the wafer support 4 in the processing chamber 1.

A gas inlet hole 11 is formed at an upper portion of a sidewall of the processing chamber 1, and an annealing gas such as Ar gas or the like is supplied from a processing gas supply source (not shown) into the processing chamber 1 through a gas line 12. A gas exhaust port 13 is formed at a bottom wall of the processing chamber 1, and a gas exhaust line 14 is connected to the gas exhaust port 13. The processing chamber 1 is set to be kept in a predetermined vacuum state by exhausting the processing chamber 1 through the gas exhaust port 13 and the gas exhaust line 14 by a vacuum pump (not shown) connected to the gas exhaust line 14. A loading/unloading port 15 through which the wafer W is loaded and unloaded is provided at a portion of the sidewall of the processing chamber 1, opposite to the gas inlet hole 11. The loading/unloading port 15 can be opened and closed by a gate valve 16.

The wafer support 4 has a vertically movable and rotatable base plate 17, a plurality of wafer support pins 18 uprightly provided on an outer peripheral surface of the base plate 17, and a rotation shaft 19 extending downward from a central portion of a bottom surface of the base plate 17. A uniform heating ring 20 made of, e.g., silicon, is provided around the wafer W supported by the wafer support pins 18. A reference numeral ‘20a’ denotes a supporting member for supporting the uniform heating ring 20.

The driving unit 5 has an elevation member 22 for raising and lowering the wafer W supported by the wafer support pins 18 of the wafer support 4 while rotatably supporting the rotation shaft 19 via a magnetic seal bearing 21, an elevation motor 23 for raising and lowering the elevation member 22, and a rotation motor 24 for rotating the wafer W supported by the wafer support 4 by using the rotation shaft 19.

A guide rail 25 extends vertically downward from the bottom portion of the processing chamber 1 while being attached to a rail base 26. A linear slide block 27 moving along the guide rail 25 is attached to the elevation member 22. The linear slide block 27 is coupled to a vertically extending ball screw 28, and a rotation shaft 23a of the elevation motor 23 is connected to a lower end of the ball screw 28 by using a coupling 29. By rotating the ball screw 28 by means of the elevation motor 23, the elevation member 22 is raised and lowered by using the linear slide block 27.

The rotation shaft 19 is extended below the magnetic seal bearing 21, and a pulley 30 is attached to a lower end portion of the rotation shaft 19. Meanwhile, a pulley 31 is attached to the rotation shaft 24a of the rotation motor 24, and the pulleys 30 and 31 are wound with a belt 32. The rotation of the rotation shaft 24a of the rotation motor 24 is transmitted to the rotation shaft 19 through the belt 32, and the wafer W supported by the wafer supporting pins 18 is rotated by the rotation shaft 19. An encoder 34 is connected to a lower end of the rotation shaft 19 by using a coupling 33.

A bellows 35 is provided between the bottom portion of the processing chamber 1 and the elevation member 22 so as to cover the rotation shaft 19. Reference numerals ‘36’ and ‘37’ denote a centering mechanism for performing centering of the elevation member 22 and a radiation thermometer, respectively.

The lamp unit 3 includes: a base member 40 provided above the processing chamber 1 so as to cover an upper opening of the processing chamber 1 while being supported by the lid 2; a plurality of halogen lamps 45 attached to a bottom surface of the base member 40, leading ends of the halogen lamps 45 facing downward; downwardly protruded three reflectors 41 to 43 provided at a bottom surface of the base member 40 concentrically (concentric circular array) to be rotationally symmetric about a portion corresponding to the center of the wafer W, in order to serve to reflect lights emitted from the halogen lamps 45; a circular plate-shaped light transmitting plate 46 serving as a light transmitting window provided between the halogen lamps 45 and the wafer W so as to airtightly seal the upper opening of the processing chamber 1 while being supported by the lid 2 via a seal 50; and a cooling head 47 serving as a cooling medium supply unit for supplying a cooling medium such as a cooling water or the like into the reflectors 41 to 43 and the base member 40.

The light transmitting plate 46 is made of a light transmitting dielectric material, e.g., quartz. The halogen lamps 45 are arranged along the reflectors 41 to 43. As for the halogen lamps 45, single ended lamps each having a single power supply portion at one side thereof are used. The power supply portion is provided at an upper portion of each of the lamps, and a leading end thereof faces downward.

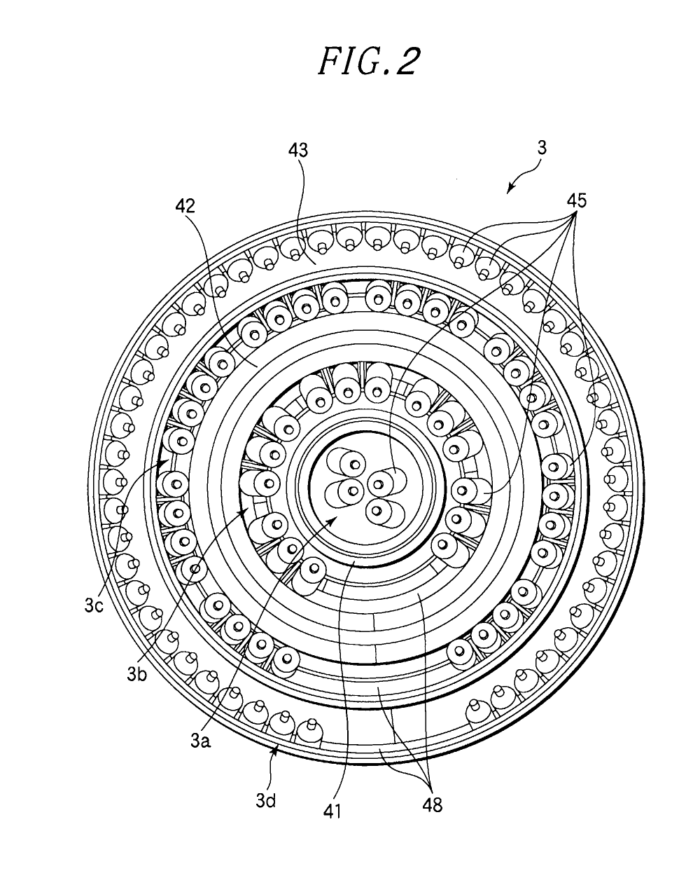

As shown in FIG. 2, the halogen lamps 45 are provided in a first zone 3a located at an inner side of the innermost reflector 41, a second zone 3b located between the reflectors 41 and 42, a third zone 3c located between the reflectors 42 and 43, and a fourth zone 3d located at an outer side of the outermost reflector 43. In order to supply a cooling water or the like, non-lamp regions 48 where the halogen lamps 45 are not provided are formed at the second zone 3b, the third zone 3c, and the fourth zone 3d. The non-lamp regions 48 in the respective zones are overlapped with each other.

The halogen lamps 45 serve as a cartridge lamp module having a plurality of lamps formed as a single unit. Specifically, as shown in FIG. 3 and FIGS. 5A to 5D, two first lamp modules 61 (see FIG. 5A) in each of which two halogen lamps 45 are attached to an attachment member 51 are provided in the innermost first zone 3a; five second Lamp modules 62 (see FIG. 5B) in each of which three halogen lamps 45 are attached to an attachment member 52 are provided in the second zone 3b; eight third lamp modules 63 (see FIG. 50) in each of which four halogen lamps 45 are attached to an attachment member 53 are provided in the third zone 3c; and ten fourth lamp modules 64 (see FIG. 5D) in each of which five halogen lamps 45 are attached to an attachment member 54 are provided in the fourth zone 3d. Each of the attachment members 51 to 54 has a power supply port (not shown) through which a power is supplied to the halogen lamps 45. The lamp modules 61 to 64 are detachably provided, and the state in which all the lamp modules are removed is illustrated in FIG. 4.

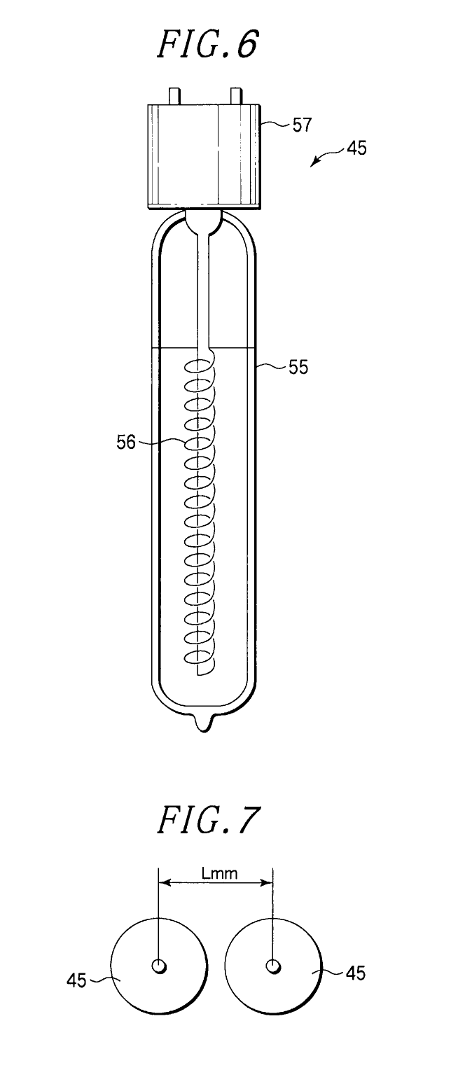

As shown in FIG. 6, each of the halogen lamps 45 has a cylindrical quartz tube 55 made of transparent quartz glass, a filament 56 disposed inside the quartz tube 55, and a power supply terminal 57 through which a power is supplied to the filament 56.

The quartz tube 55 has an outer diameter of about 18 mm. In general, a power in the range from about 100 W to 1200 W, about 1500 W at maximum, is supplied to the filament 56. At this time, if the halogen lamps 45 are turned on at a full level, a surface temperature of a quartz tube 55 of each one of the halogen lamps 45 is increased by the heat produced from the adjacent one thereof at that time. When a distance L between centers of the quartz tubes 55 of the adjacent halogen lamps 45 shown in FIG. 7 is set to be smaller than about 22 mm, the surface temperatures of the quartz tubes 55 may exceed about 1600° C., which is a softening temperature of quartz glass.

Therefore, a distance L between centers of two adjacent halogen lamps 45 is set to be preferably greater than or equal to about 22 mm. A simulation result shows that, when a heat emission rate per unit area is about 3200 W/m² and the distance L is set to be about 20 mm, the temperature reaches an extremely high level of about 3000 K (2727° C.). However, when the distance L is set to be about 22 mm, the temperature becomes lower than the softening temperature of, e.g., about 1600 K (1327° C.).

The effect of heat between the adjacent halogen lamps 45 is decreased as the distance between the adjacent halogen lamps 45 is increased. However, when the distance is increased, the heating efficiency is decreased. Therefore, it is preferable to set a maximum level of the distance L within the range in which a desired heating efficiency is obtained. Specifically, it is preferably set the distance L to be smaller than or equal to about 40 mm.

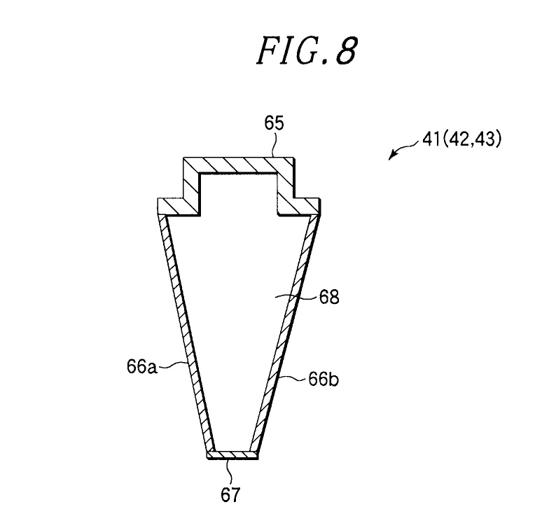

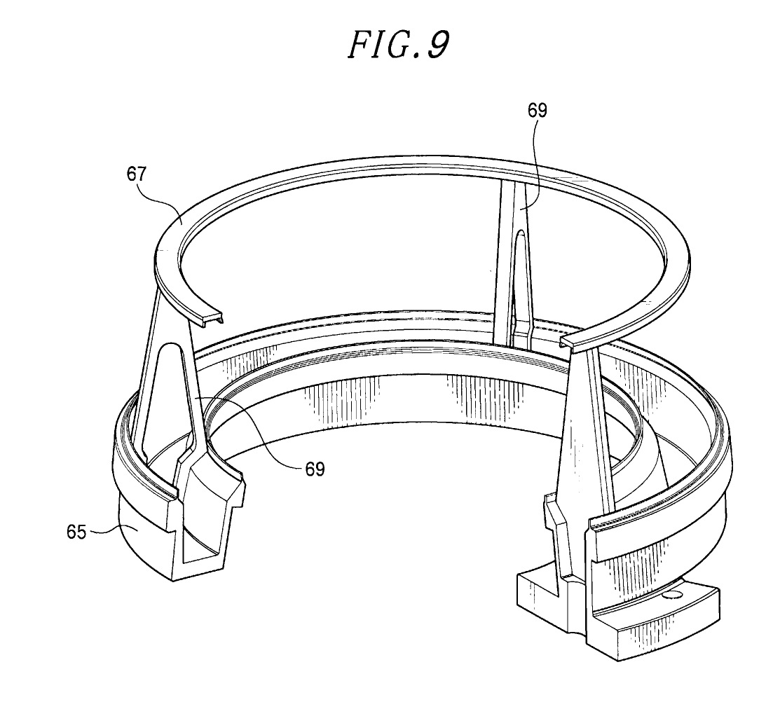

As shown in FIGS. 1 and 8, each of the reflectors 41 to 43 includes: a ring-shaped base 65 attached to an inner wall of a ceiling portion of the base member 40 and having a substantially reverse U-shaped cross section; and a ring-shaped main body 66 having a cross section which is wide at the base 65 and tapered toward the top, and having therein a ring-shaped space serving as a cooling medium channel 68 through which a cooling medium such as cooling water or the like circulates. The main body 66 has two sidewalls 66a and 66b each having an outer surface serving as a reflective surface, and a leading end wall 67 provided at the leading end sides of the sidewalls 66a and 66b. The space surrounded by the sidewalls 66a and 66b and the leading end wall 67 is used as the cooling medium channel 68.

In order to increase the cooling efficiency, each of the reflectors 41 to 43 has a structure in which the sidewalls 66a and 66b of the main body 66 are made extremely thin so that most of the inner space thereof can be used as the cooling medium channel 68. However, if the sidewalls 66a and 66b are too thin, the strengths of the reflectors 41 to 43 are decreased. In order to obtain sufficient cooling efficiency, the thickness of the sidewalls 66a and 66b is preferably set to be less than or equal to about 5 mm. In order to obtain sufficient strength, it is preferably set to be greater than or equal to about 1.2 mm.

An outer ring portion 44 positioned outside the fourth zone 3d of the base member 40 serves as a reflector, and a cooling medium channel 70 is also formed therein.

The reflectors 41 to 43 may be formed by welding, casting, forging or press molding. In view of, e.g., easy processability, it is preferable to form the reflectors 41 to 43 by welding in the following manner. First, a plurality of frame members 69 is welded to the base 65 at a plurality of locations spaced apart from each other at a proper interval and, then, the leading end wall 67 is spot-welded to the leading ends of the frame members 69, as shown in FIG. 9. In other words, a frame including the frame members 69, the leading end wall 67 and the base 65 is initially formed.

Next, metal plates forming the reflective walls 66a and 66b are attached to the frame in the state shown in FIG. 9. Specifically, the metal plates are attached between the base 65 and the leading end wall 67 along the inner and the outer peripheral portions of the frame members 69. In this manner, the reflectors 41 to 43 are fabricated. The main body 66 may be made of, e.g., stainless steel (SUS), and the reflective surface thereof is coated, e.g., gold-plated, with a material having high reflectivity.

At least some of the inner and the outer reflective surfaces of the reflectors 41 to 43 preferably form conical surfaces inclined with respect to a normal line of the top surface of the wafer W supported by the wafer supporting pins 18. Hence, lights emitted from the halogen lamps 45 can be easily transmitted to the wafer W positioned therebelow. However, in terms of the design of apparatus, it is unnecessary to incline all the surfaces of the reflectors, and the inclination angles of the reflectors at that time are preferably selected within the range from about 0° to 60°. The inclination angles of the inner and the outer surface of each reflector may be the same or different.

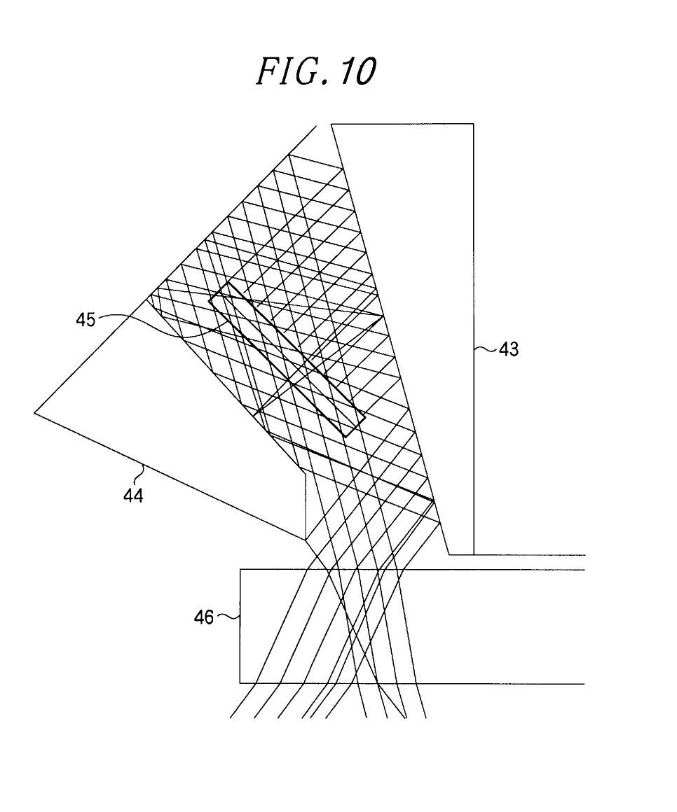

Besides, it is preferable that the halogen lamps 45 are inwardly inclined with respect to the normal line of the top surface of the wafer W supported by the wafer supporting pins 18. By inclining the halogen lamps 45, the irradiation efficiency of the lights from the halogen lamps 45 can be increased. FIG. 10 shows a simulation of lights emitted from the halogen lamp and lights reflected by the reflector when the halogen lamp in the fourth zone is inclined by about 45°.

As can be seen from FIG. 10, most of the reflected lights can be irradiated toward the wafer W by inclining the halogen lamp. The inclination angle at that time may be properly selected in accordance with the design of apparatus. However, it is preferably set to be in the range from about 5° to 47°. The inclination angles of the halogen lamps 45 can be adjusted on a zone basis. For example, the inclination can be increased from the innermost first zone toward the outermost fourth zone. Further, the inclination angles of the halogen lamps 45 may be differently set for the individual lamp modules in the respective zones.

As shown in FIG. 11, the cooling head 47 has an inlet port 71 through which a cooling medium such as cooling water or the like is introduced and an outlet port 72 through which the cooling medium is exhausted. The cooling medium supply line and the cooling medium exhaust line (both being not shown) are connected to the inlet port 71 and the outlet port 72, respectively. A cooling medium supply channel 73 connected to the inlet port 71 is formed inside the cooling head 47, and branch channels 74 to 77 branched from the cooling water supply channel 73 are respectively connected to the cooling medium channel 70, the cooling medium channel 68 of the reflector 43, the cooling medium channel 68 of the reflector 42, and the cooling medium channel 68 of the reflector 41.

A cooling medium discharge channel 78 connected to the outlet port 72 is formed inside the cooling head 47, and branch lines 79 to 82 branched from the cooling medium discharge channel 78 are respectively connected to the cooling medium channel 70, the cooling medium channel 68 of the reflector 43, the cooling medium channel 68 of the reflector 42, and the cooling medium channel 68 of the reflector 41. For convenience, the halogen lamps 45 are not illustrated in FIG. 11.

The annealing apparatus 100 further includes a control unit 90. The control unit 90 has a micro processor and mainly controls the components of the annealing apparatus 100.

Hereinafter, an operation of the annealing apparatus 100 configured as described above will be explained.

First, the gate valve 16 is opened, and a wafer W is loaded into the processing chamber 1 through the loading/unloading port 15 by a transfer arm (not shown). Then, the wafer W is mounted on the upwardly projecting wafer supporting pins 18. Next, the gate valve 16 is closed, and the wafer W is lowered to a processing position by the elevation motor 23.

Thereafter, a power is supplied to a plurality of halogen lamps 45 while rotating the wafer W. Accordingly, the halogen lamps 45 are turned on, and an annealing process is started. The lights from the halogen lamps 45 reach the wafer W through the light transmitting plate 46, and the wafer W is heated by the heat thus produced. At this time, the heating temperature is within the range from, e.g., about 700° C. to 1200° C., and the temperature increasing rate and the temperature decreasing rate of about 20° C./sec to 50° C./sec can be achieved. The irradiation energy of lights from the halogen lamps 45 to the wafer W which is greater than or equal to about 0.5 W/mm² can be achieved, which results in improvement of the temperature uniformity of the wafer W.

In that case, since the halogen lamps 45 are provided in such a way that the leading ends thereof face downward, the arrangement density of the halogen lamps can be increased compared to the case in which the halogen lamps are arranged in a planar shape as described in JP2002-064069A. Accordingly, the irradiation efficiency of the halogen lamps 45 can be increased.

The reflectors 41 to 43 are concentrically provided and the halogen lamps 45 are arranged along the reflectors 41 to 43. Therefore, lights emitted from the halogen lamps 45 can be transmitted to the wafer W without repetitive reflection occurring when light pipes are provided as reflectors as described in U.S. Pat. No. 5,840,125A1. Hence, the amount of energy absorbed as heat can be reduced and, thus, the energy efficiency can be increased.

The cooling medium channel 68 is formed of a ring-shaped space within each of the concentrically provided reflectors 41 to 43, so that the conductance of the cooling medium is decreased and this enables the reflectors 41 to 43 to be effectively cooled.

The reflectors 41 to 43 can be simply fabricated by forming the frame by using the base 65 and the frame members 69 and then attaching the metal plate forming the main body in a ring shape. Since the main body 66 having reflective surfaces is formed of the metal plate, the cooling efficiency is further increased.

The inner and the outer reflective surfaces of the reflectors 41 to 43 form the conical surfaces inclined with respect to the normal line of the top surface of the wafer W supported by the wafer supporting pins 18. Accordingly, the reflected lights of the halogen lamps 45 can be easily transmitted to the wafer W positioned therebelow. As a result, the number of reflections in the reflectors can be decreased and, thus, the irradiation efficiency can be increased. By inwardly inclining the halogen lamps 45 with respect to the normal line of the top surface of the wafer W, the emission efficiency of the light from the halogen lamps 45 can be increased.

By detachably providing the cartridge lamp modules in each of which a plurality of halogen lamps 45 is attached to the attachment portions in one lump, the maintenance operation such as exchange of the halogen lamps or the like can be easily carried out and, thus, the maintenance efficiency can be increased.

### Second Embodiment

Hereinafter, a second embodiment of the present invention will be described.

The present embodiment is characterized in that the power supply terminals 57 of the halogen lamps 45 are protected. When the halogen lamps 45 are turned on during an annealing process, the power supply terminals 57 are heated by the heat thus produced at that time. When the temperatures of the power supply terminals 57 exceed about 350° C. by such heating, Mo foil used as a conductor is rapidly oxidized and short-circuited. Therefore, in the present embodiment, the power supply terminals 57 are cooled, and lights emitted from the halogen lamps 45 are prevented from reaching the power supply terminals 57.

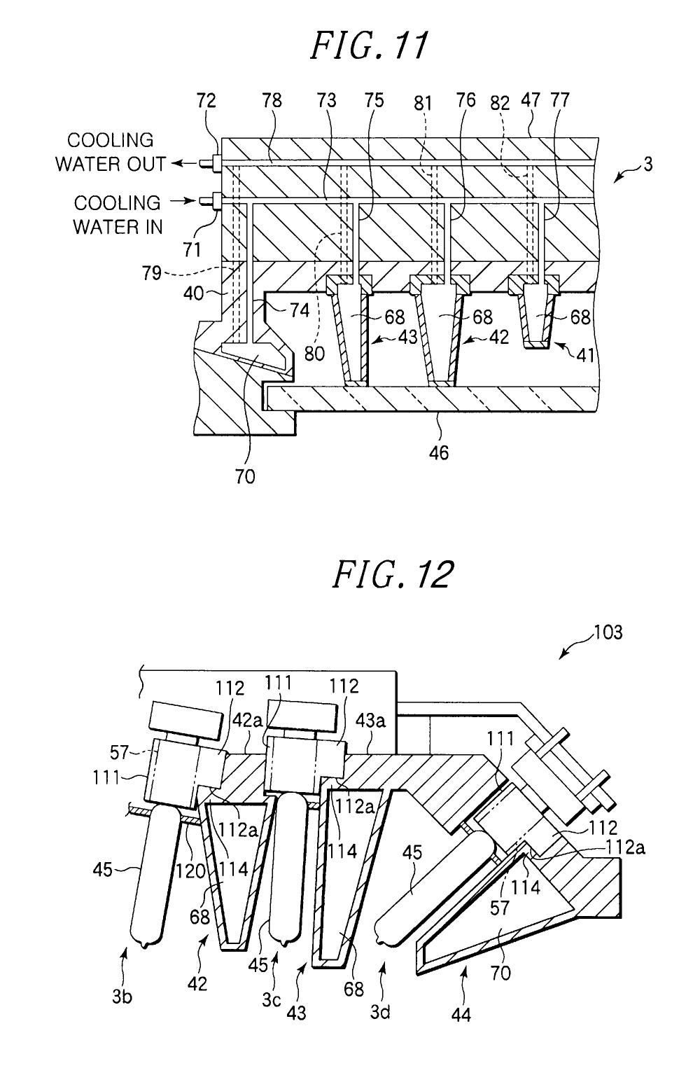

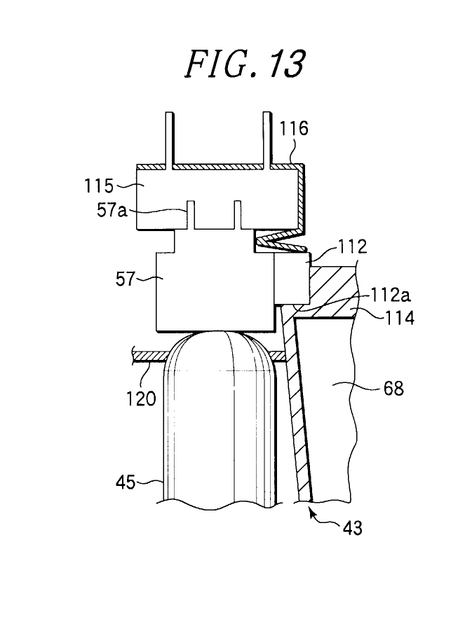

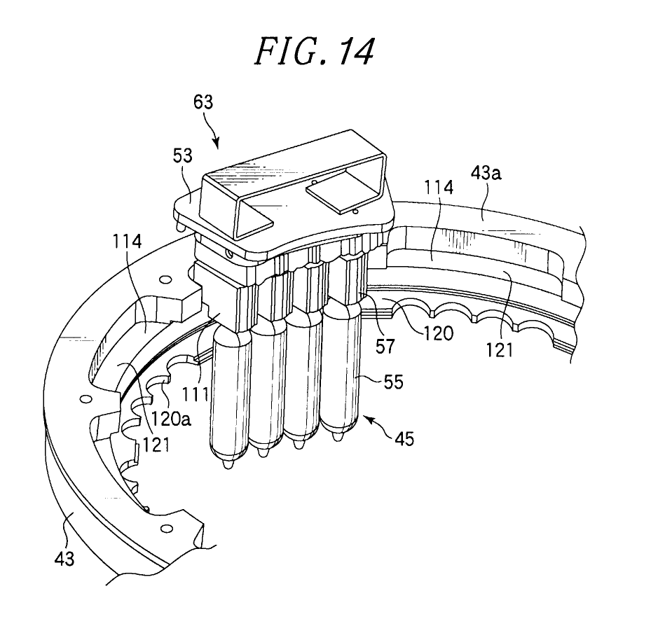

FIG. 12 is a cross sectional view showing a part of a lamp unit 103 of an annealing apparatus 100 in accordance with the second embodiment of the present invention. FIG. 13 is a cross sectional view showing principal parts thereof. FIG. 14 is a perspective view showing an attachment state of the halogen lamps 45. In the lamp unit 103 of the present embodiment, each of the halogen lamps 45 has a structure in which one power supply terminals 57 is covered by a highly conductive cooling block 111. The cooling block 111 has a protrusion 112 protruded toward the power supply terminals 57, and the bottom surface of the protrusion 112 serves as a heat radiating surface 112a.

The halogen lamps 45 are provided such that the heat radiating surfaces 112a come into contact with the cooling wall 114 cooled by the cooling medium. Accordingly, the heat of the power supply terminals 57 is transferred to the cooling blocks 111 and then radiated from the heat radiating surfaces 112a to the cooling walls 114, thereby preventing the temperature of the power supply terminals 57 from being increased excessively.

As illustrated, in the present embodiment, the reflectors 42 and 43 respectively have base rings 42a and 43a. The halogen lamps 45 in the second zone 3b use the base ring 42a as the cooling wall 114, and the halogen lamps in the third zone 3c use the base ring 43a as the cooling wall 114. The power supply terminals 57 of the halogen lamps 45 in the second and the third zone 3b and 3c are cooled by the cooling medium flowing through the cooling medium channels 68 and 68 of the reflectors 42 and 43. The halogen lamps 45 in the fourth zone 3d use as the cooling wall 114 a portion of the outer ring portion 44 which is close to the cooling medium channel 70. Although it is not shown, the halogen lamps 45 in the first zone 3a use a base ring of the reflector 41 as the cooling wall 114.

As shown in FIG. 13, an insertion portion 57a of the power supply terminal 57 is inserted into a socket 115, and the socket 115 is attached to the attachment portion of the lamp module. A plate spring 116 is attached to the socket 115 to serve as a biasing member applying a force for firmly pressing the cooling block 111 attached to the power supply terminal 57 toward the cooling wall 114. Due to the biasing force of the plate spring 116, the cooling block 111 is firmly pressed toward the cooling wall 114. As a consequence, the cooling block 111 can stably come into contact with the cooling wall 114 and, thus, the cooling performance of the power supply terminal 57 can be enhanced. Instead of the plate spring 116, another biasing member such as a coil spring or the like may be used.

A light blocking wall 120 for blocking lights emitted from the filaments 56 is provided at a portion of the quartz tubes 55 of the halogen lamps 45 which is close to the power supply terminals 57. Accordingly, the temperature increase in the power supply terminals 57 can be suppressed. A plurality of light blocking walls 120 may be provided.

FIG. 14 shows a state in which the third lamp module 63 in the third zone 3c is attached to the base ring 43a of the reflector 43. Recesses 121 are formed at the base ring 43a, and the bottoms of the recesses 121 serve as the cooling walls 114. Further, the protrusions 112 of the cooling blocks 111 attached to the four halogen lamps 45 of the third lamp module 63 are inserted to the recesses 121. Accordingly, the heat radiating surfaces 112a of the protrusions 112 come into contact with the cooling walls 114. Each lamp module in other zones has the same attachment structure.

A ring-shaped light blocking wall 120 is also provided at an inner peripheral side of the reflector 43 which is positioned immediately below the base ring 43a, and semi-circular cutoff portions 120a into which the quartz tubes 55 of the halogen lamps 45 are inserted are formed at the light blocking wall 120. A light blocking wall 120 is formed outside the reflector 42 so as to correspond to the light blocking wall 120 formed inside the reflector 43 (see FIG. 12) and, although it is not shown, semi-circular cutoff portions are formed at the light blocking wall 120 formed outside the reflector 42 so as to correspond to the cutoff portions 120a of the light blocking wall 120 formed inside the reflector 43.

Hence, in the third lamp module 63, lights emitted from the filaments 56 of the halogen lamps 45 toward the power supply terminals 57 are effectively blocked by the light blocking wall 120. In the halogen lamps 45 in the other zones, lights emitted from the filaments 56 toward the power supply terminals 57 are blocked by the light blocking wall 120 having the same structure.

In the present embodiment, the power supply terminals 57 of the halogen lamps 45 are covered by the cooling blocks 111, and the heat radiating surfaces 112a of the protrusions 112 of the cooling blocks 111 come into contact with the cooling wall 114 cooled by the cooling medium. Therefore, the heat from the power supply terminals 57 is transferred to the cooling blocks 111 and then radiated from the heat radiating surfaces 112a to the cooling wall 114, thereby preventing the temperatures of the power supply terminals 57 from being increased excessively. At this time, each of the cooling blocks 111 is firmly pressed toward the cooling wall 114 by the pressing force of the plate spring 116. As a consequence, the cooling blocks 111 can stably come into contact with the cooling wall 114 and, thus, the cooling performance of the power supply terminals 57 can be further enhanced.

The light blocking wall 120 for blocking lights emitted from the filaments 56 is provided at a portion of the quartz tubes 55 of the halogen lamps 45 which is close to the power supply terminals 57, so that the lights emitted from the filaments 56 can be prevented from reaching the power supply terminals 57. Accordingly, it is possible to suppress the breakages of the power supply terminals 57 caused by the lights emitted from the halogen lamps 45.

### Third Embodiment

Hereinafter, a third embodiment of the present invention will be described.

In the lamp unit, a seal between the light transmitting plate and the lid is positioned near the halogen lamps 45 and thus may be thermally deformed or fused by temperature increase caused by the heat generated from the halogen lamps in the lamp unit and the lights emitted from the halogen lamps. Thus, in the present embodiment, the configuration for protecting the seal will be mainly described.

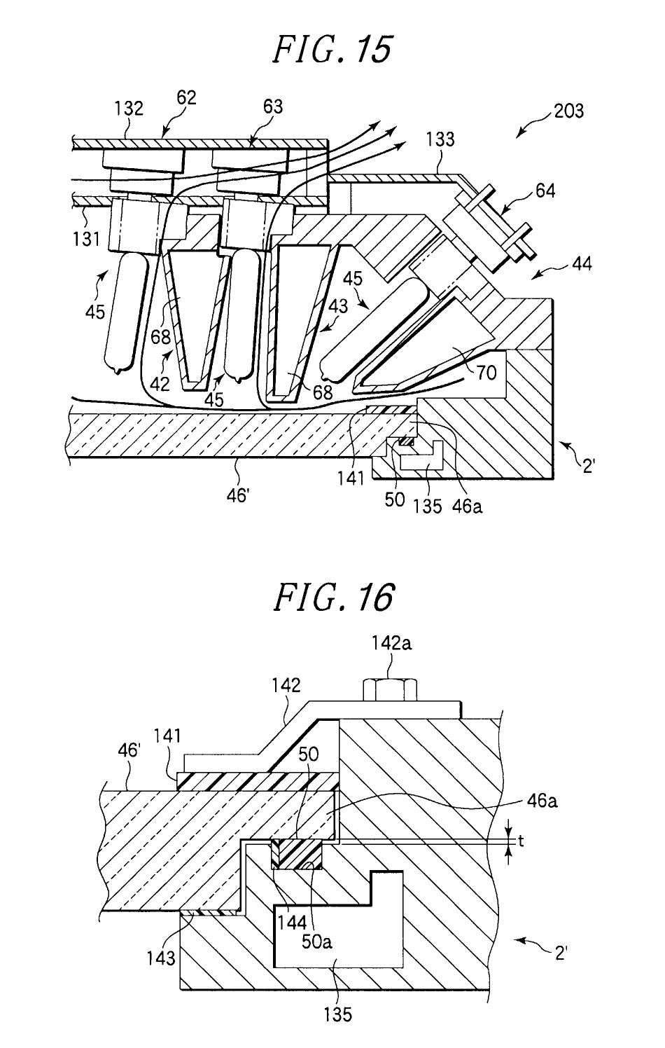

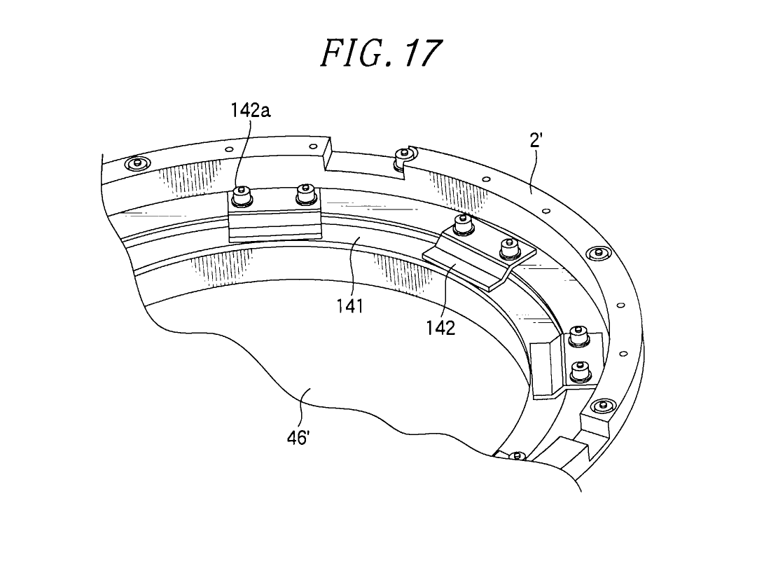

FIG. 15 is a cross sectional view showing principal parts of an annealing apparatus in accordance with the third embodiment of the present invention. FIG. 16 is a cross sectional view showing a light transmitting plate supporting portion of the annealing apparatus in accordance with the third embodiment of the present invention. The annealing apparatus of the present embodiment includes a lamp unit 203 including a light transmitting plate 46′ having a flange portion (stepped portion) 46a. The flange portion 46a of the light transmitting plate 46′ is supported by a lid 2′ serving as a base by using the seal 50.

The lamp unit 203 has two holding frame 131 and 132, respectively provided at an upper side and a lower side, for holding the first lamp module 61 in the first zone 3a, the second lamp module 62 in the second zone 3b, and the third lamp module 63 in the third zone 3c (only the second and the third lamp module 62 and 63 being shown). The holding frames 131 and 132 hold the first to the third lamp modules 61 to 63 such that the halogen lamps 45 of the respective lamp modules are separated from the reflectors adjacent thereto by about 5 mm or more. Further, the fourth lamp module 64 in the fourth zone 3d is supported by a frame 133 such that the halogen lamps are separated from the outer ring portion 44 by about 5 mm or more. Accordingly, it is possible to ensure ventilation between the halogen lamps 45 and the reflectors and between the holding frames 131 and 132.

Moreover, the ventilation indicated by arrows in FIG. 15 is ensured in the lamp unit 203 by a blower or a fan (not shown), thereby discharging heat. In other words, heat is moved from the lid 2′ side toward the inner portion of the light transmitting plate 46′ through the top surface thereof and then toward the installation parts of the halogen lamps 45. Next, the heat is flowed through the space between the halogen lamps 45 and the reflectors and then is discharged to the outside through the space between the holding frames 131 and 132. The heat generated from the halogen lamps 45 is cooled by the cooling air supplied by the fan. The seal 50 is positioned at the upstream side of the cooling air, so that the temperature increase in the seal 50 can be suppressed.

As shown in FIG. 16, the lid 2′ serving as the base has a step portion corresponding to the flange portion 46a of the light transmitting plate 46′, and an annular sealing groove 50a for accommodating the seal 50 is formed at a portion of the lid 2′, corresponding to the light transmitting plate 46′. An annular cooling medium channel 135 is formed immediately below the sealing groove 50a along the sealing groove 50a.

A ring-shaped cover 141 for preventing a direct light from reaching the seal 50 is provided at a portion of the top surface of the light transmitting plate 46′ which corresponds to the flange portion 46a. The cover 141 has a light blocking property and is made of, e.g., Teflon (Registered Trademark). As shown in FIG. 17, the cover 141 is fixed by fixing jigs 142 spaced apart from each other at a regular interval along the circumferential direction. The fixing jigs 142 are fixed to the lid 2′ by bolts 142a.

A sliding member 143 for reducing a stress caused by a thermal expansion difference between the light transmitting plate 46′ and the lid 2′ is provided between the bottom surface of the light transmitting plate 46′ and the surface of the lid 2′ which corresponds thereto. The sliding member 143 is made of a material, e.g., Teflon (Registered Trademark), having a good sliding property.

A gap “t” is formed between the bottom surface of the flange portion 46a of the light transmitting plate 46′ and the surface of the lid 2′ which corresponds thereto. The stepped portion t is greater than or equal to about 0.5 mm, so that the force applied to the seal is reduced. In order to prevent the seal 50 from being inwardly strained due to the presence of the gap t, a support ring 144 made of a hard resin is provided at an inner side of the seal 50 in the sealing groove 50a.

In the present embodiment, the lamp unit 203 has a ventilation structure in which heat is flowed from the lid 2′ side toward the inner side of the light transmitting plate 46′ through the top surface thereof and then is flowed upward through the space between the halogen lamps 45 and the reflectors, and then is discharged to the outside through the space between the holding frames 131 and 132. The heat generated from the halogen lamps 45 is cooled by the cooling air supplied by the fan. The seal 50 is positioned at the upstream side of the cooling air, the temperature of the atmosphere of the portion where the seal is disposed can be decreased, and the temperature increase in the seal 50 can be suppressed.

The seal 50 is cooled by a cooling medium flowing in the cooling medium channel 135, thereby suppressing the temperature increase in the seal 50. Moreover, the light transmitting cover 141 is provided on the top surface of the flange portion 46a which corresponds to the seal 50 of the light transmitting plate 46′, so that a direct light is prevented from entering the seal 50 from the lamp unit 203 and, thus, the temperature increase in the seal 50 by the direct light is prevented. Further, the light transmitting plate 46′ has such a stepped structure provided with the flange portion 46a, so that the intrusion of a scattered light to the seal 50 is suppressed.

The thermal expansion difference between the light transmitting plate 46′ made of, e.g., quartz, and the lid 2′ made of a metal material is large, and therefore, a thermal stress is generated between the light transmitting plate 46′ and the lid 2′ due to the lights irradiated from the halogen lamps 45 to the light transmitting plate 46′. However, in the present embodiment, the sliding member 143 having a good sliding property is provided between the bottom surface of the light transmitting plate 46′ and the surface corresponding to the lid 2′, so that the thermal stress therebetween is reduced and, thus, the breakage of the light transmitting plate 46′ is prevented. Moreover, the stepped portion that is greater than or equal to about 0.5 mm in thickness is formed between the bottom surface of the flange portion 46a of the light transmitting plate 46′ and the surface of the lid 2′ which corresponds thereto, so that it is not necessary for the atmospheric pressure to be supported by the thin flange portion 46a and, thus, the breakage of the light transmitting plate 46′ can be prevented.

### Fourth Embodiment

Hereinafter, a fourth embodiment of the present invention will be described. The present embodiment is characterized by the arrangement of the halogen lamps 45.

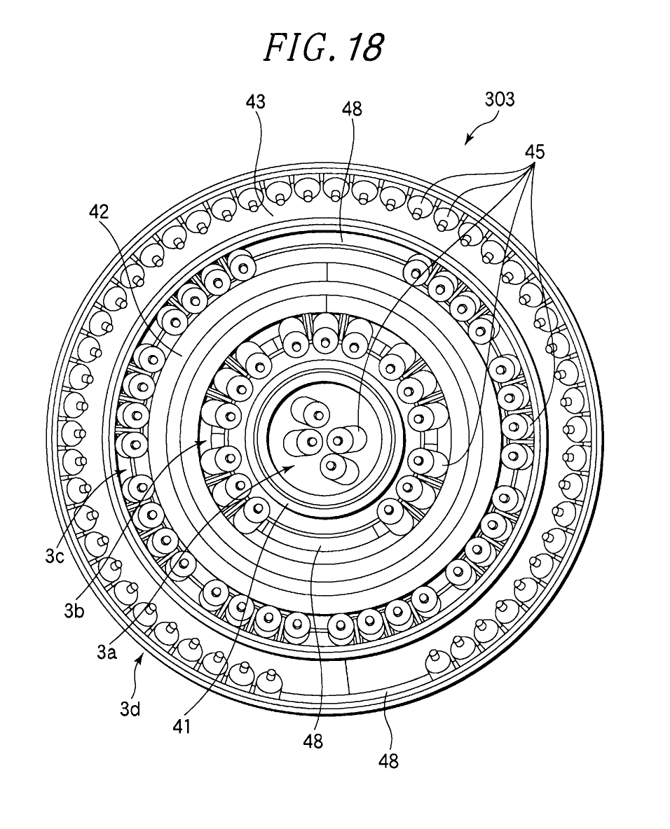

FIG. 18 is a bottom view showing a lamp unit 303 of an annealing apparatus in accordance with the fourth embodiment of the present invention. As in the first embodiment, the lamp unit 303 includes three reflectors 41 to 43, and the halogen lamps 45 are provided in the first zone 3a located at the portion inner than the innermost reflector 41, the second zone 3b located between the reflectors 41 and 42, the third zone 3c located between the reflectors 42 and 43, and the fourth zone 3d located at the portion outer than the outermost reflector 43.

In the present embodiment, the halogen lamps 45 are arranged such that the adjacent non-lamp regions 48 of the second to the fourth zone 3b to 3d are not overlapped with each other. Specifically, the non-lamp regions 48 of the second and the fourth zone 3b and 3d correspond to each other, and the non-lamp region 48 of the third zone 3c therebetween is positioned at the side opposite to the non-lamp regions 48 of the second and the fourth zone 3b and 3d.

In the present embodiment, an annealing process is performed while rotating the wafer W, so that the uniformity of the heating is not affected even when the non-lamp regions 48 adjacent thereto are overlapped with each other. Since, however, the light transmitting plate 46 is not rotated, the overlapped arrangement of the non-lamp regions leads to non-uniform heating of the light transmitting plate 46. Therefore, by-products volatilized from the wafer are selectively deposited on the low-temperature region of the light transmitting plate 46 and, thus, the transmissivity of the light transmitting plate 46 are partially deteriorated.

On the other hand, the light transmitting plate 46 can be further uniformly heated by misaligning the non-lamp regions 48 in the adjacent zones as in the present embodiment. The arrangement of the non-lamp regions 48 is not limited to the one shown in FIG. 18, and another arrangement may be employed. For example, the non-lamp regions of the second to the fourth zone 3b to 3d may be misaligned by about 120°.

### Fifth Embodiment

Hereinafter, a fifth embodiment of the present invention will be described. The present embodiment is also characterized by the arrangement of the halogen lamps 45.

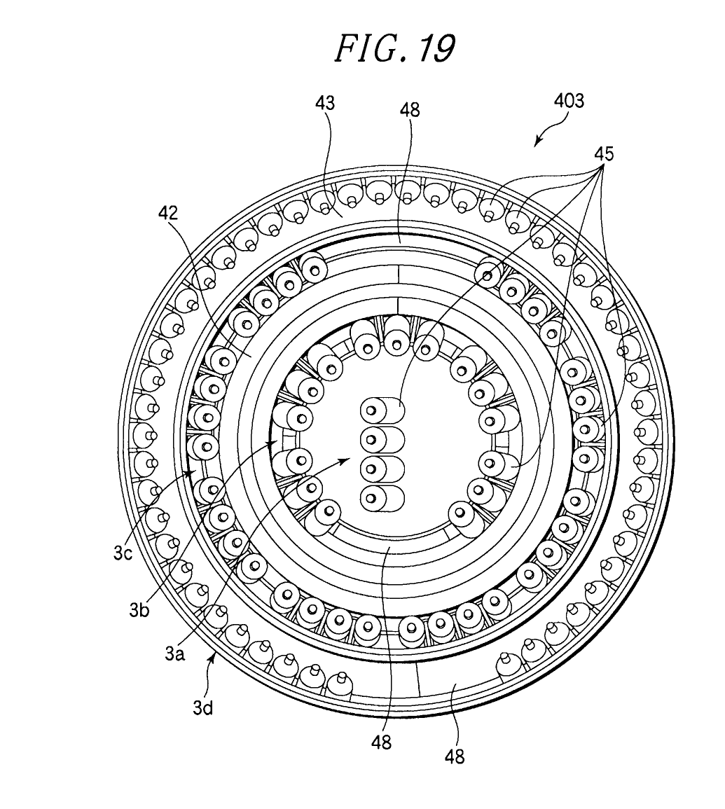

FIG. 19 is a bottom view showing a lamp unit 403 of an annealing apparatus in accordance with a fifth embodiment of the present invention. The lamp unit 403 of the present embodiment is different from the lamp unit 303 of the fourth embodiment in that the innermost reflector 41 is not provided and also in that the four halogen lamps 45 in the first zone 3a are arranged on a linear line. The other configurations are the same as those of the fourth embodiment.

In the fourth embodiment, the gap between the halogen lamps 45 in the first zone 3a and the second zone 3b is large, and the region where the lamp light hardly reaches may exist, which may lead to non-uniform heating of the central portion of the wafer W. In other words, due to the presence of the innermost reflector 41, the arrangement positions of the halogen lamps 45 are limited and the uniform irradiation may be hindered. Since the wafer W is rotating, lights may be emitted to a larger area when the halogen lamps 45 are arranged in a linear shape.

Therefore, in the fifth embodiment, the five halogen lamps 45 in the first zone 3a are arranged on a linear line without providing the innermost reflector 41 to thereby uniformly heat the inner region of the wafer W.

The present invention may be variously modified without being limited to the above embodiments. For example, in the above embodiments, there has been described the annealing apparatus as an example of the heat treatment apparatus. However, another apparatus in which a target substrate to be processed needs to be heated, such as a film forming apparatus or the like, may also be employed. Besides, in the above embodiments, three concentric reflectors are provided. However, the present invention is not limited thereto, and two or more reflectors may be provided in accordance with the size of the target substrate and/or the arrangement of the halogen lamps.

In the above embodiments, there have also been described the example in which halogen lamps are used as lamps. However, the present invention is not limited thereto as long as a lamp capable of heating is employed. A double ended lamp may be used instead of a single ended lamp used in the above embodiments. In that case, the lamp may be formed in a U-shape such that two power supply terminals are disposed at upper portions thereof and a curved portion thereof serves as a leading end portion.

In the above embodiments, there have been described the example in which the lamp unit is provided above the processing chamber so as to face the opening formed on the top surface of the processing chamber. However, the lamp unit may be provided below the processing chamber so as to face an opening formed on the bottom surface of the processing chamber.

In the above embodiments, there have been described the case in which a semiconductor wafer is used as a target substrate to be processed. However, another substrate such as an FPD (flat panel display) substrate or the like may also be used. Besides, in the above embodiments, the reflectors are provided concentrically about a circular semiconductor wafer. However, when a rectangular substrate, e.g., an FPD substrate, is used, the reflectors may be arranged in a rectangular shape.

As long as it is made within the scope of the present invention, the modification in which the components of such embodiments are properly combined or the modification in which some of the components of the above embodiments are omitted is included in the present invention.

What is claimed is:

1. A heat treatment apparatus comprising:
a processing chamber for accommodating therein a target substrate to be processed;
a substrate supporting unit for horizontally supporting the target substrate in the processing chamber;
a lamp unit for emitting lights to the target substrate supported by the substrate supporting unit through an opening formed at the processing chamber; and
a lamp unit supporting unit for supporting the lamp unit,
wherein the lamp unit includes:
a plurality of lamps whose leading ends face the target substrate supported by the substrate supporting unit;
a base member holding the lamps;
a plurality of ring-shaped reflectors provided at the base member concentrically about a portion corresponding to the center of the target substrate and protruded toward the target substrate, the reflectors serving to reflect the lights emitted from the lamps toward the target substrate; and
a cooling medium supply unit for supplying a cooling medium into the reflectors,
wherein at least some of the lamps are arranged along the reflectors, and cooling medium channels, each inner space of which is formed as a ring-shaped space, are respectively provided within the reflectors in extending directions of the reflectors.

2. The heat treatment apparatus of claim 1, further comprising a rotation mechanism for rotating the substrate supporting unit,
wherein the target substrate is heated by the lamps while being rotated by the rotation mechanism.

3. The heat treatment apparatus of claim 1, wherein each of the reflectors defines a cooling medium channel and includes sidewalls each of which has an outer surface serving as a reflective surface and has a thickness in a range from about 1.2 mm to 5 mm.

4. The heat treatment apparatus of claim 1, wherein each of the reflectors is formed to be rotationally symmetric about a portion corresponding to a center of the target substrate.

5. The heat treatment apparatus of claim 4, wherein at least some of inner and the outer reflective surfaces of the reflectors form conical surfaces inclined with respect to a normal line of surface of the target substrate supported by the substrate supporting unit.

6. The heat treatment apparatus of claim 1, wherein the inner and outer reflective surfaces of the reflectors are disposed at an angle in a range from about 0° to 60° with respect to a normal line of a surface of the target substrate supported by the substrate supporting unit.

7. The heat treatment apparatus of claim 1, wherein the lamps are inwardly inclined with respect to a normal line of a surface of the target substrate supported by the substrate supporting unit.

8. The heat treatment apparatus of claim 7, wherein the inclination angles of the lamps range between about 5° and about 47°.

9. The heat treatment apparatus of claim 1, further comprising a plurality of lamp modules, each having a structure in which two or more of the lamps are attached to an attachment member,
wherein the lamp modules are detachably attached to the base member.

10. The heat treatment apparatus of claim 1, wherein each of the lamps has a transparent quartz tube and a filament provided at a central portion in the transparent quartz tube, and
wherein a distance between centers of the quartz tubes of the adjacent lamps is greater than or equal to about 22 mm and smaller than or equal to about 40 mm.

11. The heat treatment apparatus of claim 1, wherein each of the lamps has a transparent quartz tube, a filament provided in the transparent quartz tube, and a power supply terminal for supplying power to the filaments, and the lamp unit further includes a cooling block for cooling the power supply terminals by contact therewith,
wherein the cooling block has a heat radiation surface which comes into contact with a cooling wall cooled by a cooling medium.

12. The heat treatment apparatus of claim 11, wherein the cooling wall is cooled by the cooling medium circulating through the reflectors.

13. The heat treatment apparatus of claim 11, wherein the lamp unit further includes a biasing member applying a force for pressing the cooling block toward the cooling wall.

14. The heat treatment apparatus of claim 1, wherein the lamp unit further includes a light blocking wall for preventing the lights emitted from the lamps from reaching the power supply terminals.

15. The heat treatment apparatus of claim 14, wherein the light blocking wall is provided at the reflectors.

16. The heat treatment apparatus of claim 1, wherein the lamp unit further includes a light transmitting member which covers the opening of the processing chamber and transmits the lights irradiated from the lamps,
wherein the light transmitting member is supported by the lamp unit supporting unit.

17. The heat treatment apparatus of claim 16, wherein the lamp unit further includes a seal provided between the light transmitting member and the lamp unit supporting unit.

18. The heat treatment apparatus of claim 17, wherein the lamp unit has a ventilation structure for discharging heat generated from the lamps.

19. The heat treatment apparatus of claim 18, wherein the base member of the lamp unit has a frame which holds the lamps such that the lamps are separated from the reflectors adjacent thereto by about 5 mm or more.

20. The heat treatment apparatus of claim 17, wherein the lamp unit supporting unit has, near a portion where the seal is provided, a cooling medium channel through which a cooling medium for cooling the seal circulates.

21. The heat treatment apparatus of claim 17, wherein a cover for blocking the lights emitted from the lamp unit toward the seal is provided on a top surface of the light transmitting member.

22. The heat treatment apparatus of claim 17, wherein a sliding member having a sliding property is provided between a supported surface of the light transmitting member and a supporting surface of the lamp unit supporting unit.

23. The heat treatment apparatus of claim 17, wherein a sealing groove into which the seal is inserted is formed at the lamp unit supporting unit;
the seal inserted in the sealing groove and the surface of the light transmitting member are sealed by close contact made therebetween; and
a gap which is greater than or equal to about 0.5 mm is formed between the surface of the lamp unit supporting unit where the sealing groove is formed and the surface of the light transmitting member.
